(19) United States
(12) Patent Application Publication
(10) Pub. No.: US 2008/0046944 A1
(43) Pub. Date: Feb. 21, 2008

(54) UBIQUITOUS HOME MEDIA SERVICE APPARATUS AND METHOD BASED ON SMMD, AND HOME MEDIA SERVICE SYSTEM AND METHOD USING THE SAME

(76) Inventors: Hae-Ryong LEE, Daejon (KR); Sang-Hyun JOO, Daejon (KR); Jae-Kwan YUN, Seoul (KR); Kwang-Roh PARK, Daejon (KR); Chae-Kyu KIM, Daejon (KR); Dong-Won HAN, Daejon (KR); Myung-Joon KIM, Daejon (KR); Kyeong-Deok MOON, Daejon (KR); Jeun-Woo LEE, Daejon (KR); In-Tark HAN, Daejon (KR); Sung-Jin HUR, Daejon (KR); Eui-Hyun PAIK, Daejon (KR)

Correspondence Address: LADAS & PARRY LLP, 224 SOUTH MICHIGAN AVENUE, SUITE 1600, CHICAGO, IL, 60604, US

(21) Appl. No.: 11/840,386

(22) Filed: Aug. 17, 2007

(30) Foreign Application Priority Data
Aug. 17, 2006 (KR) 10-2006-0077841
Sep. 20, 2006 (KR) 10-2006-0091314

(51) Int. Cl. H04N 7/173

(52) U.S. Cl. 725/110

(57) ABSTRACT

Provided is a ubiquitous home media service apparatus and method based on single media multi devices (SMMD). The apparatus includes: a database for storing sensor information, a device profile, a user profile, and ne-media; a user interface for requesting the ne-media to an external ne-media providing server and receiving the corresponding ne-media; a ne-media process unit for dividing the received ne-media into neo-data, media including audio/video/text, synchronization/control information of each device, and identification (ID) information; a ne-media playing unit for playing the divided media; a device control and synchronizing unit for discovering peripheral device information, generating a cooperating device group, generating a synchronization signal, and recording the synchronization signal; and a network managing unit for transmitting the ne-media from the device control and synchronizing unit to a peripheral device play apparatus and a play auxiliary apparatus.

### FIELD OF THE INVENTION

The present invention relates to a ubiquitous home media service apparatus and method based on single media multi devices (SMMD), and a home media service system and method using the same; and, more particularly, to a ubiquitous home media service apparatus and method based on SMMD, and a home media service system and method using the same that devices having diverse peripheral functions are automatically united through the ne-media with no regard to a physical location of a user such as home, office or public places and provide a realistic media service to the user by generating media of a new format, i.e., ne-media, which can add device control and synchronization information for providing realistic senses to conventional media including a moving picture, an audio and a text, inputting reality representation information corresponding to a personal taste and a peripheral device environment in the generated ne-media, and transmitting the reality representation information to a peripheral device.

### DESCRIPTION OF RELATED ART

A media service apparatus of the present invention can be applied to a set-top box and a digital television (DTV) at home, and Smart Phone, Personal Digital Assistant (PDA), and Portable Multimedia Player (PMP) on the move. In a ubiquitous Information Technology (IT) age, an intelligent technology will be complexly applied to the media based on automatic cooperation between a reality technology for satisfying the five senses of human and a device. It is difficult to realize the technology according to a method for playing a media in one device. That is, when diverse devices for reality cooperate with the media and the device is operated based on media information, the technology can be realized.

The majority of a current media service is a single media single device (SMSD)-based service that one media is played in one device. One media should be a service based on single media multi devices (SMMD), which is played when one media is realized by cooperating with a plurality of devices, to maximize media play effect at ubiquitous home.

Microsoft (MS) has been progressing “Easy Living” project for developing a prototype structure and technology to build an intelligent environment. SONY and Intel have been developing a technology for realizing a ubiquitous home where a service and contents are provided in a format desired by the user.

In Korea, Samsung Electronics provides “Digital Home”, which is a living environment connected by a Smart Home, related to a digital home and ubiquitous IT. LG CNS develops a core solution required for realizing ubiquitous computing. Daelim I&S promotes a ubiquitous-based digital apartment business. KT and SKT provide a commercial service related to a media service such as simple home appliances control, home automation, Internet Protocol Television (IPTV), and a TV portal.

However, effective play of the media is ruled out in the above development and only portability of the media using a network such as Digital Multimedia Broadcasting (DMB) and Wibro is considered. Since an expensive digital device developed for the digital home does not provide mobility, it is difficult to evolve into the ubiquitous home.

A reality/intelligent ubiquitous home technology requires diverse high technologies such as a wired/wireless home network technology, a cooperation technology between devices, a device synchronization/control technology, a context aware technology, and a location/identification/authentication technology of the device. Also, competition between nations will be highly intensive to acquire a future source technology.

The media should be basically played with diverse digital devices to realize the reality/intelligent ubiquitous home media service. However, it is not possible to realize the reality/intelligent ubiquitous home media service according to a conventional media playing method or a digital device operating method.

The media of the ubiquitous age will be developed from the media such as an image, a voice, and a text into an evolved media such as a hologram. Also, the media of the ubiquitous age should be played with no regard to devices anytime and anywhere.

While aiming at an interactive service or a customized service using diverse additional information metadata added to a current media, a killer application through portable devices such as a mobile phone, PDA, and PMP appears in medical service, education, and entertainment fields in spite of the limitation of display.

A technology, which will be required next time, may be a ubiquitous home media service technology for maximizing media play effect with no regard to devices anytime and anywhere.

### SUMMARY OF THE INVENTION

It is, therefore, an object of the present invention to provide a ubiquitous home media service apparatus and method based on single media multi devices (SMMD), and a home media service system and method using the same that devices having diverse peripheral functions are automatically united through the ne-media with no regard to a physical location of a user such as home, office or public places and provide a realistic media service to the user by generating a media of a new format, i.e., ne-media, which can add device control and synchronization information for providing realistic services to a conventional media including a moving picture, an audio and a text, inputting reality representation information corresponding to personal taste and a peripheral device environment in the generated ne-media, and transmitting the reality representation information to a peripheral device.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

In accordance with an aspect of the present invention, there is provided a a ubiquitous home media service apparatus based on single media multi devices (SMMD), including: a database for storing sensor information, a device profile, a user profile, and ne-media; a user interface for requesting the ne-media to an external ne-media providing server and receiving the corresponding ne-media; a ne-media process unit for dividing the received ne-media into neo-data, media including audio/video/text, synchronization/control information of each device, and identification (ID) information; a ne-media playing unit for playing the divided media; a device control and synchronizing unit for discovering peripheral device information, generating a cooperating device group, generating a synchronization signal between the media and the device based on synchronization information of the divided ne-media, and recording the synchronization signal in the ne-media; and a network managing unit for transmitting the ne-media from the device control and synchronizing unit to a peripheral device play apparatus and a play auxiliary apparatus.

In accordance with another aspect of the present invention, there is provided a ubiquitous home media service method based on SMMD, including the steps of: a) requesting ne-media to an external ne-media providing server and receiving the corresponding ne-media; b) dividing the received ne-media into neo-data, media including audio/video/text, synchronization/control information of each device and ID information; c) discovering peripheral device information, generating a cooperating device group, generating a synchronization signal between the media and the device based on the synchronization information of the divided ne-media, and recording the synchronization signal in the ne-media; d) transmitting the ne-media recording the generated information to a peripheral device including a play apparatus and a play auxiliary apparatus; and e) playing the ne-media synchronously with the transmitted peripheral device.

In accordance with another aspect of the present invention, there is provided a ubiquitous home media service system SMMD, including: a ne-media providing server for analyzing contents of media including audio/video/text, generating an operation timing, a parameter setup value, and a control value of the device based on the analyzed data such that a specific device can be cooperated for a specific time, recording the operation timing, the parameter setup value, and the control value of the device with the device information in the ne-media, and generating the ne-media; a home media service apparatus for dividing the generated ne-media into neo-data, the media including the audio/video/text, synchronization/control information of each device and ID information, collecting peripheral device information, generating a cooperating device group, generating a synchronization signal between the media and the device based on the synchronization information of the divided ne-media, recording the synchronization signal in the ne-media, and playing the ne-media synchronously with a corresponding device; and at least one device for receiving the ne-media while maintaining a session with the home media service apparatus, performing an authentication process, acquiring resources for playing the ne-media when the authentication process is normally performed, setting up the device in an optimal state for cooperating with the home media service apparatus, and playing the ne-media according to a device operation order.

In accordance with another aspect of the present invention, there is provided a ubiquitous home media service method SMMD, including the steps of: a) analyzing contents of media including audio/video/text, generating an operation timing, a parameter setup value, and a control value of a device based on the analyzed data such that a specific device can be cooperated for a specific time, recording the operation timing, the parameter setup value, and the control value of the device with the device information in the ne-media, and generating the ne-media; b) dividing the generated ne-media into neo-data, the media including the audio/video/text, synchronization/control information of each device and ID information, collecting peripheral device information, generating a cooperating device group, generating a synchronization signal between the media and the device based on the synchronization information of the divided ne-media, recording the synchronization signal in the ne-media, and playing the ne-media synchronously with a corresponding peripheral device; and c) receiving the ne-media while maintaining a session with the home media service apparatus, performing an authentication process, acquiring resources for playing the ne-media when the authentication process is normally performed, setting up the device in an optimal state for cooperating with the home media service apparatus, and playing the ne-media according to a device operation order.

Meanwhile, the ne-media of the present invention includes additional information such as aroma, smell, the sense of touch, temperature/humidity as well as an image, voice and a text, which are materials of the conventional media.

Also, since the ne-media of the present invention directly has ID information differently form the conventional media format, it is possible to play the ne-media while the user is moving.

Also, the present invention is applied to a fixed device, which is fixed in a specific place such as a home server, and a mobile device such as a mobile phone and can play the ne-media.

Also, the present invention is compatible with diverse communication protocols such as an IP network, IEEE 1934, UWB, and ZigBee. Since the present invention provides standard interface of a digital device, it does not require an individual connecting work.

Also, the present invention can cooperate with a device capable of self-control by an application program through the CPU such as Smart Phone, and PDA and the memory and simple home appliances such as a TV and an audio.

In order to manage frequency of use and propensity of the user, the present invention manages the profile of each device, automatically senses peripheral apparatuses, and authenticates whether the devices can be used. When the memory is insufficient and it is difficult to play the ne-media, one device shares resources with other device having a peripheral memory and acquires a function for self-organizing the device.

The present invention inserts a synchronization and control code of the device in the inside of the ne-media. Accordingly, the peripheral play apparatuses and the play auxiliary apparatuses automatically synchronize with the media at a specific part of the media and automatically play the effect.

Also, when the play apparatus and the play auxiliary apparatus are insufficient to maximize the effect of the ne-media, the devices of the present invention cooperate each other and can play the effect of the ne-media.

Since the present invention can add neo-data for providing a specific effect to the generated ne-media, it is possible to produce customized media.

The ne-media of the present invention is applied to profile information such as the user, the device, and the environment at home.

### BRIEF DESCRIPTION OF THE DRAWINGS

The above and other objects and features of the present invention will become apparent from the following description of the preferred embodiments given in conjunction with the accompanying drawings, in which:

FIG. 1 shows a ne-media reference model in accordance with an embodiment of the present invention;

FIG. 2 shows a data structure of the ne-media in accordance with an embodiment of the present invention;

FIG. 3 shows a ubiquitous home media service apparatus based on single media multi devices (SMMD) in accordance with an embodiment of the present invention;

FIG. 4 is a block diagram showing a database of the ubiquitous home media service apparatus based on SMMD in accordance with the embodiment of the present invention;

FIG. 5 is a block diagram showing a user interface of the ubiquitous home media service apparatus based on SMMD in accordance with the embodiment of the present invention;

FIG. 6 is a block diagram showing a ne-media process managing unit of the ubiquitous home media service apparatus based on SMMD in accordance with the embodiment of the present invention;

FIG. 7 is a block diagram showing a ne-media play managing unit of the ubiquitous home media service apparatus based on SMMD in accordance with the embodiment of the present invention;

FIG. 8 is a diagram showing a device control and synchronization managing unit of the ubiquitous home media service apparatus based on SMMD in accordance with the embodiment of the present invention;

FIG. 9 is a block diagram showing a network managing unit of the ubiquitous home media service apparatus based on SMMD in accordance with the embodiment of the present invention;

FIG. 10 is a block diagram showing a sensor managing unit of the ubiquitous home media service apparatus based on SMMD in accordance with the embodiment of the present invention;

FIG. 11 is a block diagram showing a condition recognition and process managing unit of the ubiquitous home media service apparatus based on SMMD in accordance with the embodiment of the present invention;

FIG. 12 is a block diagram showing a resource share managing unit of the ubiquitous home media service apparatus based on SMMD in accordance with the embodiment of the present invention;

FIG. 13 is a block diagram showing a play auxiliary apparatus in accordance an the embodiment of the present invention;

FIG. 14 is a block diagram showing a play apparatus in accordance with an embodiment of the present invention; and

FIG. 15 is a flowchart describing a ubiquitous home media service method based on SMMD in accordance with an embodiment of the present invention.

### DETAILED DESCRIPTION OF THE INVENTION

Other objects and advantages of the present invention will become apparent from the following description of the embodiments with reference to the accompanying drawings. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

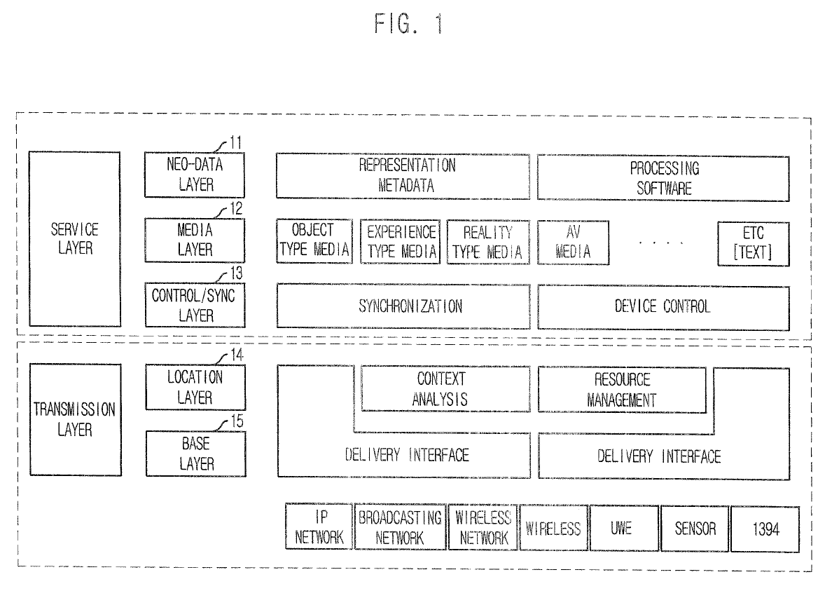

FIG. 1 is a block diagram showing a ne-media reference model in accordance with an embodiment of the present invention.

A conventional media includes metadata for simply accepting a request of a user in video and audio information. However, the media reference model of the present invention has a structure that control information, software, synchronization information, reality information are added to the conventional media. Accordingly, the user can actively respond to, select and experience the media.

The conventional media requires only one device for restoration. However, in ne-media, many devices operating by being synchronized by the ne-media can exist in diverse environments. Also, since the media cooperate with the device, it is possible to provide a service of a new format. The ne-media accept all conventional media.

The reference model of the ne-media will be described in detail hereinafter. The ne-media includes a neo-data layer 11, a media layer 12, a control/sync layer 13, a location layer 14 and a base layer 15 to define an environment and set up a peripheral device, thereby individually realizing the functions in any environment.

The neo-data layer 11 stores software for restoring reality information and software for controlling the device as well as conventional metadata.

The media layer 12 records all existing media such as an audio, a video, and a text. Also, the media layer 12 records newly appearing media information such as object type media, experience type media, and reality type media.

Also, the control/sync layer 13 records control information and synchronization information of the device for realistically playing the ne-media.

The location layer 14 records identification (ID) information on the device, which can be operated by the ne-media, such as a digital television (DTV), a mobile phone, and Personal Digital Assistant (PDA).

Also, the base layer 15 records a protocol for transmitting the ne-media and environment information for playing the ne-media.

The ne-media can include pre-serviced media and a media service method by selecting the layer structure and suggests a guideline for development of the media, which will be formed in the future. Since it is possible to selectively use each layer if necessary, burden on development can be reduced.

A transmission layer including the location layer 14 and the base layer 15 can transmit the ne-media according to diverse methods such as transmission through the network, transmission through the broadcasting media, and transmission based on the mobile device. For example, in case of a movie service based on the ne-media reference model, the base layer 15 may be formed in a basic format for playing Digital Versatile Disc (DVD). Also, when the transmitting method through the network is adopted, the base layer 15 may be formed in a format for transmission through the network. In case of cable TV and terrestrial broadcasting, the base layer 15 is formed in a format for broadcasting. When the service is provided in a digital home, the location layer 14 includes information on the devices for playing the ne-media such as TV, a mobile phone, and PDA.

A service layer is used to play the ne-media. The neo-data layer 11, the media layer 12 and the control/sync layer 13 cooperate one another. That is, when a home server receives the ne-media through the transmission layer in providing of the reality type service in the digital home, the home server analyzes a code included in the control/sync layer 13 and sets up the home server in a state that the registered peripheral devices can cooperate.

Subsequently, software in the neo-data layer 11 operates and plays the ne-media. Corresponding peripheral devices automatically display data of an object type and a reality type in the neo-data layer 11 according to a control and synchronizing signal.

Since information on device control and reality effect may be different every device, it is preferred to receive the information from a device manufacturer. It is also possible to collect more realistic data through a semantic web. Also, the user suggests satisfaction on the reality effect of a specific scene through on-line, thereby creating user participant type media where highly satisfactional reality effect is preferentially selected and the level of the media is incrementally raised.

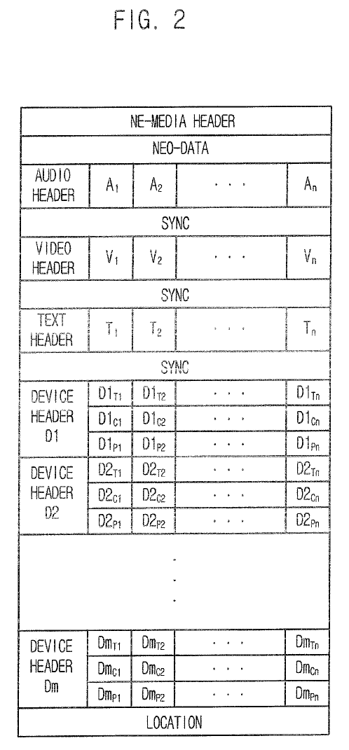

FIG. 2 shows a data structure of the ne-media in accordance with the embodiment of the present invention.

A header of a media format exists in ne-media data of the present invention and conventional metadata are included in the neo-data layer. The audio, video, and text information are synchronized one another and formed in the media layer. The audio, video, and text information are synchronized with device information to be cooperated. Time, control, and parameter information are inputted in each of device information. The device information additionally includes information on the location layer and the base layer.

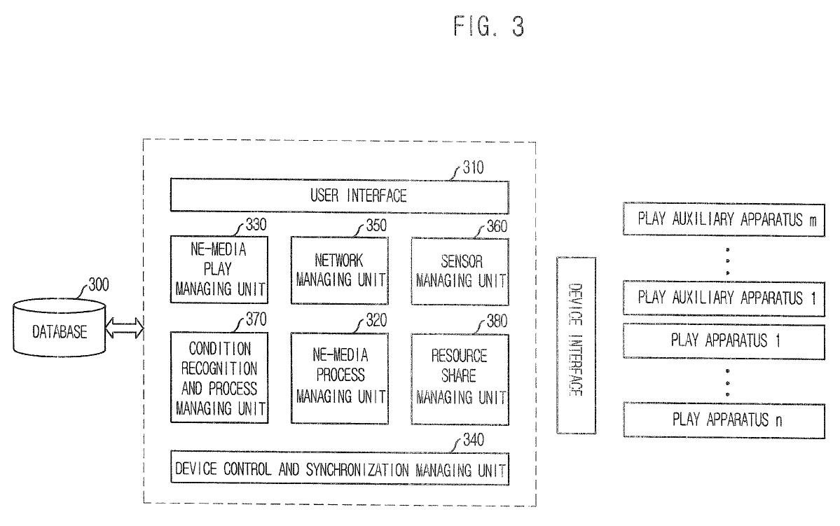

FIG. 3 shows a ubiquitous home media service apparatus based on single media multi devices (SMMD) in accordance with the embodiment of the present invention.

The ubiquitous home media service apparatus based on SMMD includes a database 300, a user interface 310, a ne-media process managing unit 320, a ne-media play managing unit 330, a device control and synchronization managing unit 340, and a network managing unit 350.

The database 300 stores sensor information, a device profile, a user profile, and the ne-media. The user interface 310 requests the ne-media to an external ne-media providing server and receives the corresponding ne-media.

The ne-media process managing unit 320 divides the ne-media transmitted from the user interface 310 into neo-data, the media including the audio/video/text, synchronization/control information of each device and ID information.

The ne-media play managing unit 330 plays media divided in the ne-media process managing unit 320.

The device control and synchronization managing unit 340 collects peripheral device information and generates a cooperating device group. Also, the device control and synchronization managing unit 340 generates a synchronization signal between the media and the device based on synchronization information of the ne-media divided in the ne-media process managing unit 320 and records the synchronization signal in the ne-media.

The network managing unit 350 transmits the ne-media from the device control and synchronization managing unit 340 to the peripheral device.

Additionally, the ubiquitous home media service apparatus based on SMMD further includes a sensor managing unit 360 and a condition recognition and process managing unit 370. The sensor managing unit 360 provides sensor information that the device control and synchronization managing unit 340 uses to collect information on the peripheral device such as a play apparatus and a play auxiliary apparatus. The condition recognition and process managing unit 370 provides inference information that the device control and synchronization managing unit 340 uses to select a specific device among the collected devices and generates a device group.

Also, the ubiquitous home media service apparatus based on SMMD further includes a resource share managing unit 380 for allocating resources when resources for playing the ne-media of the device are insufficient.

Functions of a ne-media providing server will be described in detail hereinafter.

The ne-media providing server includes a ne-media generator for transforming conventional media including the audio/video/text into the ne-media.

A contents analyzer of the ne-media generator analyzes contents of the media including the audio/video/text, generates an operation timing, a parameter setup value, and a control value of the device based on the analyzed data such that a specific device can cooperate for a specific time, and records the operation timing, the parameter setup value, and the control value of the device in the ne-media with the device information.

For example, in a moving picture scene that a rose is given, the rose diffuses the aroma for a while as soon as the rose is given. Information on an operation time, a duration time, and intensity of an aroma diffusing device are recorded. The device information is generated based on metadata provided in the conventional media. Even if the metadata are not provided, the device information can be generated through contents-based media analyzing/processing procedure.

As described above, a specific device is selected at a specific time. The device synchronization/control information is generated and inputted in the ne-media synchronization/control layer. A software agent for controlling a corresponding device or device controller information is inputted in the neo-data layer of the ne-media with the conventional metadata.

Also, device ‘Location’ information around the user to cooperate with the media is the ID of a device determined by a main device receiving the ne-media such as a home server, a set-top box, and a mobile terminal. The location layer is set up into 0, i.e., a reserve state, before being transmitted to the user.

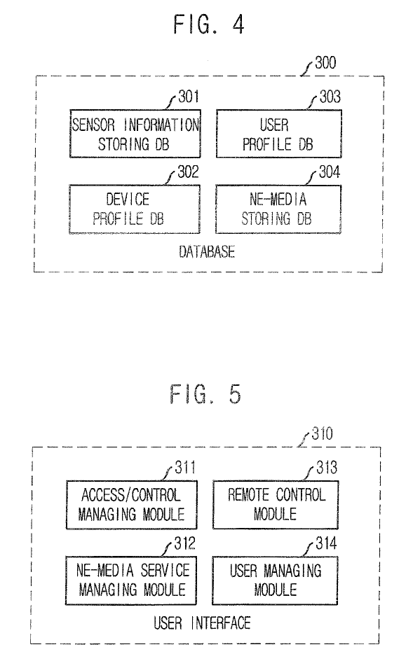

Each constitutional element will be described in detail with reference to FIGS. 4 to 12. FIG. 4 is a block diagram showing a database of the ubiquitous home media service apparatus based on SMMD in accordance with the embodiment of the present invention.

The database 300 of the ubiquitous home media service apparatus based on SMMD includes a sensor information storing DB 301 for managing sensor information, a device profile DB 302 for managing a device profile, a user profile DB 303 for managing a user profile and a ne-media storing DB 304 for storing the ne-media. The sensor information storing DB 301 is a storing means for storing/updating/deleting/searching data generated when the ubiquitous home media service apparatus based on SMMD is operated.

FIG. 5 is a block diagram showing the user interface of the ubiquitous home media service apparatus based on SMMD in accordance with the embodiment of the present invention.

The user interface 310 of the ubiquitous home media service apparatus based on SMMD includes an access/control managing module 311, a ne-media service managing module 312, a remote control module 313, and a user managing module 314.

The access/control managing module 311 manages whether the user can access and control. The ne-media service managing module 312 requests the ne-media to the external ne-media providing server, receives the ne-media and manages service progress matters of the ne-media. The remote control module 313 provides an external remote control function when the home media service apparatus is applied to the home server. The user managing module 314 manages a permitted user.

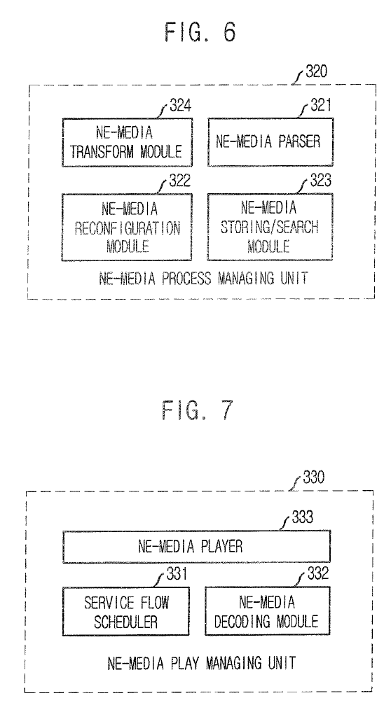

FIG. 6 is a block diagram showing the ne-media process managing unit of the ubiquitous home media service apparatus based on SMMD in accordance with the embodiment of the present invention.

The ne-media process managing unit 320 of the ubiquitous home media service apparatus based on SMMD according to the present invention includes a ne-media parser 321, a ne-media reconfiguration module 322, and a ne-media storing/search module 323. The ne-media process managing unit 320 additionally includes a ne-media transform module 324.

The ne-media parser 321 divides the ne-media, which are provided from the external ne-media providing server through the user interface 310, into the neo-data, the media including the audio/video/text, synchronization/control information of each device and ID information. The ne-media reconfiguration module 322 re-configurates the ne-media. The ne-media storing/search module 323 stores the ne-media. The ne-media transform module 324 transforms the ne-media provided from the external ne-media providing server into other media format.

FIG. 7 is a block diagram showing the ne-media play managing unit of the ubiquitous home media service apparatus based on SMMD in accordance with the embodiment of the present invention.

The ne-media play managing unit 330 of the ubiquitous home media service apparatus according to the present invention includes a service flow scheduler 331, a ne-media decoding module 332, and a ne-media player 333.

The service flow scheduler 331 determines a play order of the ne-media. The ne-media decoding module 332 decodes the ne-media transmitted in a stream format. The ne-media player 333 plays the ne-media, i.e., the media including the audio/video/text, decoded in the ne-media decoding module 332 according to the play order determined in the service flow scheduler 331

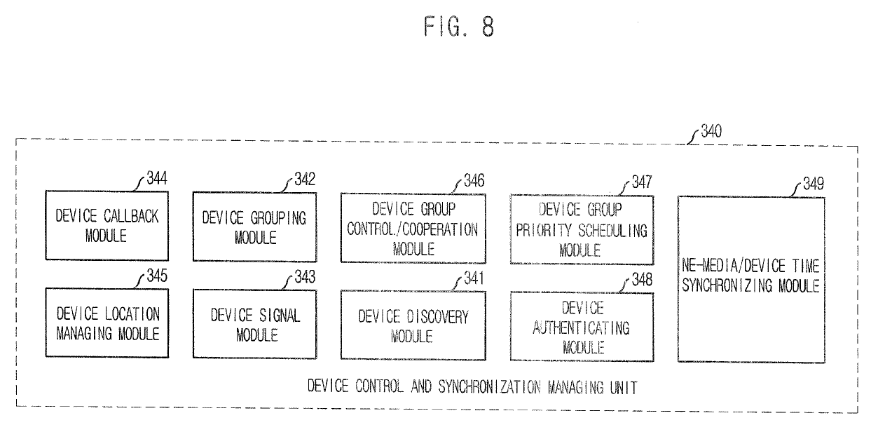

FIG. 8 is a diagram showing the device control and synchronization managing unit of the ubiquitous home media service apparatus based on SMMD in accordance with the embodiment of the present invention.

The device control and synchronization managing unit 340 of the ubiquitous home media service apparatus based on SMMD according to the present invention includes a device discovery module 341, a device grouping module 342, a device signal module 343, a device callback module 344, a device location managing module 345, a device group control/cooperation module 346, a device group priority scheduling module 347, a device authenticating module 348, and a ne-media/device time synchronizing module 349.

The device discovery module 341 discovers peripheral device information. The device grouping module 342 generates a device group to be cooperated among the devices discovered in the device discovery module 341. The device signal module 343 generates a synchronization/control signal between the ne-media and the device based on the synchronization/control information of the ne-media divided by the ne-media process managing unit 320. The device callback module 344 receives a response from the device play apparatus and the play auxiliary apparatus. The device location managing module 345 manages ID of the device play apparatus and the play auxiliary apparatus. The device group control/cooperation module 346 controls and manages the device on the basis of group unit. The device group priority scheduling module 347 determines a ne-media operation priority in the device group. The device authenticating module 348 determines whether to use a corresponding device and maintains the information. The ne-media/device time synchronizing module 349 has the device operate at an exact time according to the synchronization/control signal.

FIG. 9 is a block diagram showing the network managing unit of the ubiquitous home media service apparatus based on SMMD in accordance with the embodiment of the present invention.

The network managing unit 350 of the ubiquitous home media service apparatus based on SMMD according to the present invention includes a session managing module 351, a routing module 352, a load distribution managing module 353, and a transcoding module 354.

The session managing module 351 is a managing unit for managing connection in diverse wired/wireless environment such as an IP network, a broadcasting network, ZigBee, and IEEE 1394. The session managing module 351 maintains/manages a session between the main device and the play apparatus or the play auxiliary apparatus. The routing module 352 performs routing on the ne-media to a device of a specific location. The load distribution managing module 353 manages a load in the network transmission. The transcoding module 354 reduces and transmits the high-capacity ne-media correspondingly to the device.

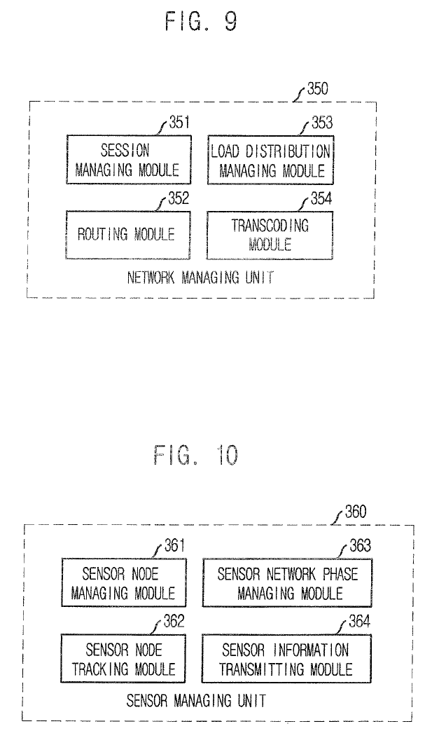

FIG. 10 is a block diagram showing the sensor managing unit of the ubiquitous home media service apparatus based on SMMD in accordance with the embodiment of the present invention.

The sensor managing unit 360 of the ubiquitous home media service apparatus based on SMMD according to the present invention includes a sensor node managing module 361, a sensor node tracking module 362, a sensor network phase managing module 363, and a sensor information transmitting module 364.

The sensor node managing module 361 manages a kind of sensors and a location. The sensor node tracking module 362 backtracks the sensor. The sensor network phase managing module 363 manages a phase of the sensor. The sensor information transmitting module 364 transmits sensor information.

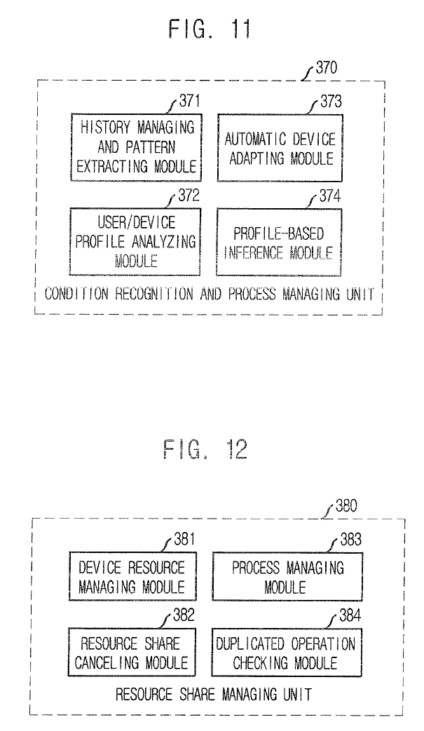

FIG. 11 is a block diagram showing the condition recognition and process managing unit of the ubiquitous home media service apparatus based on SMMD in accordance with the embodiment of the present invention.

The condition recognition and process managing unit 370 of the ubiquitous home media service apparatus based on SMMD according to the present invention includes a history managing and pattern extracting module 371, a user/device profile analyzing module 372, an automatic device adapting module 373, and a profile-based inference module 374 for inference.

The history managing and pattern extracting module 371 extracts a history and a pattern of the device. The user/device profile analyzing module 372 analyzes a profile. The automatic device adapting module 373 automatically adapts the ne-media to the device.

FIG. 12 is a block diagram showing the resource share managing unit of the ubiquitous home media service apparatus based on SMMD in accordance with the embodiment of the present invention.

The resource share managing unit 380 of the ubiquitous home media service apparatus based on SMMD according to the present invention includes a device resource managing module 381, a resource share canceling module 382 for canceling allocated resources, a process managing module 383 for managing a process in the device, and a duplicated operation checking module 384 for preventing duplicated operations due to routing errors.

The device resource managing module 381 is a managing unit for sharing the peripheral devices and the resources when it is difficult to accept digital information for providing a specific effect in one device.

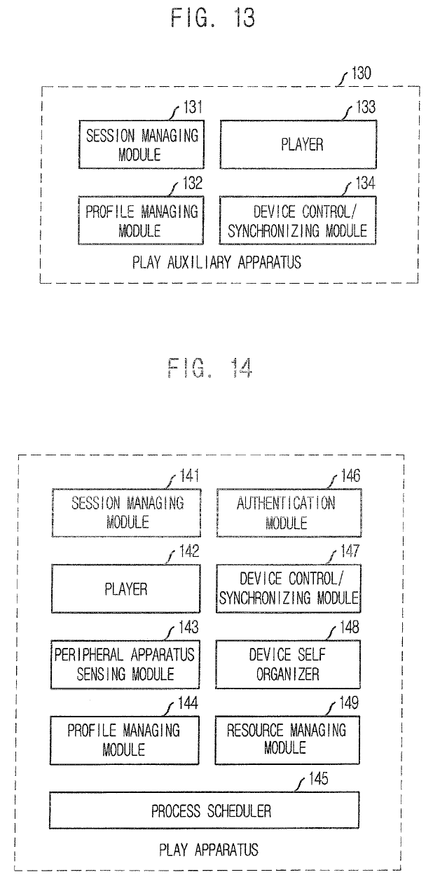

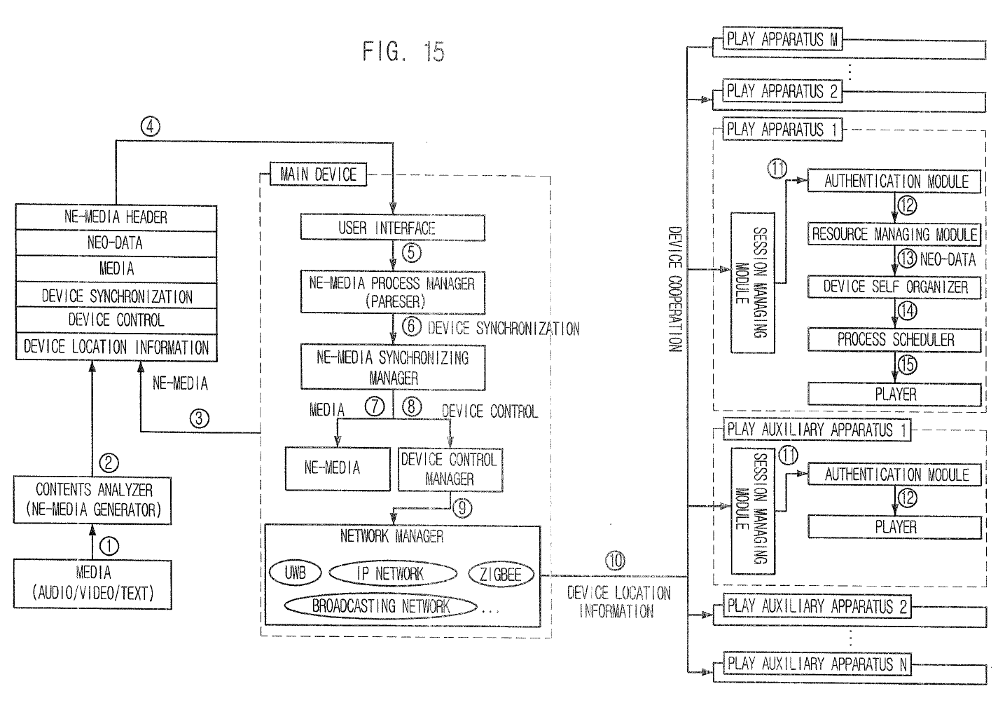

The device including the play auxiliary apparatus and the play apparatus will be described in detail with reference to FIGS. 13 and 14.

FIG. 13 is a block diagram showing the play auxiliary apparatus in accordance with the embodiment of the present invention.

The play auxiliary apparatus according to the present invention is an apparatus which is connected through a network without Central Processing Unit (CPU) such as a TV, an audio system, an aroma diffusing device, a vibration sofa and illumination, or a memory. The play auxiliary apparatus can be controlled by the ne-media. The play auxiliary apparatus 130 includes a session managing module 131, a profile managing module 132, a player 133, and a device control/synchronizing module 134.

The session managing module 131 maintains and manages connection with the ubiquitous home media service apparatus based on SMMD. The profile managing module 132 manages the device profile. The device control/synchronizing module 134 controls and synchronizes the player for playing the ne-media.

FIG. 14 is a block diagram showing the play apparatus in accordance with the embodiment of the present invention.

The play apparatus of the present invention is an apparatus which independently plays the ne-media with the CPU such as Smart Phone, a mobile phone, a set-top box, and a DTV, and a memory, and cooperates with the peripheral play apparatus.

The play apparatus includes a session managing module 141, a player 142, a peripheral apparatus sensing module 143, a profile managing module 144, a process scheduler 145, an authentication module 146, a device control/synchronizing module 147, a device self organizer 148, and a resource managing module 149.

The session managing module 141 maintains and manages connection with the ubiquitous home media service apparatus based on SMMD. The player 142 plays the ne-media. The peripheral apparatus sensing module 143 searches the peripheral apparatus for playing the ne-media. The profile managing module 144 manages the device profile. The process scheduler 145 performs process scheduling on the device. The authentication module 146 performs a user authentication process for allowing only a permitted user to access to the device. The device control/synchronizing module 147 controls and synchronizes the device. The device self organizer 148 automatically changes its own state according to the set up state while cooperating with the peripheral device. The resource managing module 149 manages the resources of the device.

FIG. 15 is a flowchart describing a ubiquitous home media service method based on SMMD in accordance with an embodiment of the present invention.

The ne-media generator of the ne-media providing server analyzes contents of the media including the audio/video/text through a contents analyzer. Subsequently, the ne-media generator generates an operation timing, a parameter setup value, and a control value of the device based on the analyzed data such that a specific device can cooperate for a specific time, and records the operation timing, the parameter setup value, and the control value of the device with device information in the ne-media at steps \textcircled{1} and \textcircled{2}.

That is, a specific device is selected at a specific time. The synchronization/control information of the selected device is generated and inputted in the ne-media synchronization/control layer.

Also, a software agent for controlling a corresponding device or device controller information is inputted in the neo-data layer of the ne-media with the conventional metadata.

Also, device ‘Location’ information around the user, which will cooperate with the media, is defined as a reserve state of 0.

The user interface 310 requests the ne-media to the ne-media providing server and receives the corresponding ne-media at steps \textcircled{3} and \textcircled{4}.

The user interface 310 transmits the received ne-media to the ne-media process managing unit 320 at step \textcircled{5}.

The ne-media process managing unit 320 divides the received ne-media into the neo-data, the media including audio/video/text, the synchronization/control information of each device and the ID information at step \textcircled{6}.

A preparing procedure for playing the media divided in the ne-media process managing unit 320 is performed and the media are played synchronously to the device to be controlled by the ne-media at step \textcircled{7}.

The device control and synchronization managing unit 340 discovers peripheral device information, generates a cooperating device group, generates a synchronization signal between the media and the device based on the synchronization information of the ne-media divided in the ne-media process managing unit 320, and records the synchronization signal in the ne-media at step \textcircled{8}.

The network managing unit 350 transmits the ne-media from the device control and synchronization managing unit 340 to the peripheral device including the play apparatus and the play auxiliary apparatus at steps \textcircled{9} and \textcircled{10}.

The session managing module of the play apparatus maintains a session with the ubiquitous home media service apparatus based on SMMD, receives the ne-media, and performs an authentication process. When the authentication process is normally performed, the session managing module of the play apparatus acquires resources for playing the ne-media, sets up the device in an optimal state for cooperation with the ubiquitous home media service apparatus based on SMMD through a device self-organizer, sets up the device operation order, and plays the device in a player based on the process scheduler at steps \textcircled{11} to \textcircled{15}.

The play auxiliary apparatus receives the ne-media from the ubiquitous home media service apparatus based on SMMD maintaining a session through the session managing module and performs the authentication process. When the authentication process is normally performed, the play auxiliary apparatus plays the ne-media.

Meanwhile, the play apparatus and the play auxiliary apparatus interactively communicate with a plurality of other play apparatuses and play auxiliary apparatuses through a wireless network. Accordingly, when other play apparatuses and play auxiliary apparatuses are registered in the ubiquitous home media service apparatus based on SMMD and are not searched, the play apparatus and the play auxiliary apparatus perform a routing function for transmitting the ne-media from the ubiquitous home media service apparatus based on SMMD to the corresponding play apparatus or play auxiliary apparatus.

The present invention can provide a ubiquitous home media service apparatus and method based on SMMD, and a home media service system and method using the same that devices having diverse peripheral functions are automatically united through the ne-media with no regard to a physical location of a user such as home, office or public places and provide a realistic media service to the user by generating media of a new format, i.e., ne-media, which can add device control and synchronization information for providing realistic services to a conventional media including a moving picture, an audio and a text, inputting reality representation information corresponding to a personal taste and a peripheral device environment in the generated ne-media, and transmitting the reality representation information to a peripheral device.

Also, the present invention is applied to diverse fields where the media are used such as a reality type service, an object type service, complex device cooperation cyber education, a medical service/health care, a game and home entertainment by maximizing media effect in ubiquitous home which emphasizes mobility such as DMB, Smart Phone, and PDA. Accordingly, the present invention may grow together with related industries through realization of the higher value-added service by creating a service in cooperation with broadcasting, a movie, contents, and a device manufacturer.

The present invention develops a new system for the ubiquitous age. Accordingly, the system can be developed independently from software without limitation by conventional hardware. Also, the present invention can build infrastructure where the media and the device can cooperate based on a converged service and create a new business model. The present invention makes it possible to expect development of a new earning model in a digital home appliances industry, a service industry, and a media industry by creating a new service, which is not realized by the conventional device/media such as generation, transmission, play and service of new concept media, and cooperation with the device.

As described above, the technology of the present invention can be realized as a program and stored in a computer-readable recording medium, such as CD-ROM, RAM, ROM, floppy disk, hard disk and magneto-optical disk. Since the process can be easily implemented by those skilled in the art of the present invention, further description will not be provided herein.

The present application contains subject matter related to Korean patent application Nos. 2006-0077841 and 2006-0091314, filed with the Korean Intellectual Property Office on Aug. 17, 2005 and Sep. 20, 2005, respectively, the entire contents of which are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A ubiquitous home media service apparatus based on single media multi devices (SMMD), comprising:
a database for storing sensor information, a device profile, a user profile, and ne-media;
a user interface means for requesting the ne-media to an external ne-media providing server and receiving the corresponding ne-media;
a ne-media process means for dividing the received ne-media into neo-data, media including audio/video/text, synchronization/control information of each device, and identification (ID) information;
a ne-media playing means for playing the divided media;
a device control and synchronizing means for discovering peripheral device information, generating a cooperating device group, generating a synchronization signal between the media and the device based on synchronization information of the divided ne-media, and recording the synchronization signal in the ne-media; and
a network managing means for transmitting the ne-media from the device control and synchronizing means to a peripheral device play apparatus and a play auxiliary apparatus.

2. The apparatus as recited in claim 1, further comprising:
a sensor managing means for providing sensor information that the device control and synchronizing means discovers the peripheral device information;
a condition recognizing and process means for selecting a specific device among the discovered devices and providing inference information used to generate a device group; and
a resource share managing means for allocating resources when the resources for playing the ne-media of the peripheral device are insufficient.

3. The apparatus as recited in claim 1, wherein the ne-media providing server analyzes contents of the media including audio/video/text, generates an operation timing, a parameter setup value, and a control value of the device based on the analyzed data such that a specific device can be cooperated for a specific time, records the operation timing, the parameter setup value, and the control value of the device with the device information in the ne-media, and sets up a device location layer around user to cooperate with the media into a reserve state of 0.

4. The apparatus as recited in claim 3, wherein the play apparatus receives the ne-media while maintaining a session with the ubiquitous home media service apparatus based on SMMD, performs an authentication process, acquires resources for playing the ne-media when the authentication process is normally performed, sets up the device in an optimal state for cooperating with the ubiquitous home media service apparatus based on SMMD through a device self-organizer, sets up a device operation order by using a process scheduler, and plays the ne-media in a player.

5. The apparatus as recited in claim 4, wherein the ne-media includes:
a neo-data layer for storing software for playing metadata and reality information and software for controlling the device;
a media layer for storing media including the audio/video/text and media information such as object type media, experience type media, and reality type media;
a control/sync layer for recording control information and synchronization information of the device for realistically playing the ne-media;
a location layer for recording device information which can be operated by the ne-media; and
a base layer for recording a protocol for transmitting the ne-media and environment information for playing the ne-media.

6. A ubiquitous home media service method based on single media multi devices (SMMD), comprising the steps of:
a) requesting ne-media to an external ne-media providing server and receiving the corresponding ne-media;
b) dividing the received ne-media into neo-data, media including audio/video/text, synchronization/control information of each device and identification (ID) information;
c) discovering peripheral device information, generating a cooperating device group, generating a synchronization signal between the media and the device based on the synchronization information of the divided ne-media, and recording the synchronization signal in the ne-media;
d) transmitting the ne-media recording the generated information to a peripheral device including a play apparatus and a play auxiliary apparatus; and
e) playing the ne-media synchronously with the transmitted peripheral device.

7. The method as recited in claim 6, further comprising the step of:
f) sharing resources when resources for playing the ne-media that the play apparatus receives are insufficient.

8. The method as recited in claim 6, wherein the ne-media includes:
a neo-data layer for storing software for playing metadata and reality information and software for controlling the device;
a media layer for storing media including the audio/video/text and media information which includes object type media, experience type media, and reality type media;
a control/sync layer for recording control information and synchronization information of the device for realistically playing the ne-media;
a location layer for recording device information which can be operated by the ne-media; and
a base layer for recording a protocol for transmitting the ne-media and environment information for playing the ne-media.

9. A ubiquitous home media service system based on single media multi devices (SMMD), comprising:
a ne-media providing server for analyzing contents of media including audio/video/text, generating an operation timing, a parameter setup value, and a control value of the device based on the analyzed data such that a specific device can be cooperated for a specific time, recording the operation timing, the parameter setup value, and the control value of the device with the device information in the ne-media, and generating the ne-media;
a home media service apparatus for dividing the generated ne-media into neo-data, the media including the audio/video/text, synchronization/control information of each device and identification (ID) information, collecting peripheral device information, generating a cooperating device group, generating a synchronization signal between the media and the device based on the synchronization information of the divided ne-media, recording the synchronization signal in the ne-media, and playing the ne-media synchronously with a corresponding device; and
at least one device for receiving the ne-media while maintaining a session with the home media service apparatus, performing an authentication process, acquiring resources for playing the ne-media when the authentication process is normally performed, setting up the device in an optimal state for cooperating with the home media service apparatus, and playing the ne-media according to a device operation order.

10. The system as recited in claim 9, wherein the ne-media includes:
a neo-data layer for storing software for playing metadata and reality information and software for controlling the device;
a media layer for storing media including the audio/video/text and media information which includes object type media, experience type media, and reality type media;
a control/sync layer for recording control information and synchronization information of the device for realistically playing the ne-media;
a location layer for recording device information which can be operated by the ne-media; and
a base layer for recording a protocol for transmitting the ne-media and environment information for playing the ne-media.

11. A ubiquitous home media service method based on single media multi devices (SMMD), comprising the steps of:
a) analyzing contents of media including audio/video/text, generating an operation timing, a parameter setup value, and a control value of a device based on the analyzed data such that a specific device can be cooperated for a specific time, recording the operation timing, the parameter setup value, and the control value of the device with the device information in the ne-media, and generating the ne-media;
b) dividing the generated ne-media into neo-data, the media including the audio/video/text, synchronization/control information of each device and identification (ID) information, collecting peripheral device information, generating a cooperating device group, generating a synchronization signal between the media and the device based on the synchronization information of the divided ne-media, recording the synchronization signal in the ne-media, and playing the ne-media synchronously with a corresponding peripheral device; and
c) receiving the ne-media while maintaining a session with the home media service apparatus, performing an authentication process, acquiring resources for playing the ne-media when the authentication process is normally performed, setting up the device in an optimal state for cooperating with the home media service apparatus, and playing the ne-media according to a device operation order.

12. The method as recited in claim 11, wherein the ne-media includes:
a neo-data layer for storing software for playing metadata and reality information and software for controlling the device;
a media layer for storing media including the audio/video/text and media information which includes object type media, experience type media, and reality type media;
a control/sync layer for recording control information and synchronization information of the device for realistically playing the ne-media;
a location layer for recording device information which can be operated by the ne-media; and
a base layer for recording a protocol for transmitting the ne-media and environment information for playing the ne-media.
